(19) United States
(12) Patent Application Publication
(10) Pub. No.: US 2010/0244400 A1
(43) Pub. Date: Sep. 30, 2010

(54) METHOD AND SYSTEM FOR DISPOSAL OF WASTE

(76) Inventors: Maor Ben-Hammo, Sderot (IL); Itzhak Pomerantz, Kfar Saba (IL)

Correspondence Address: Pearl Cohen Zedek Latzer, LLP, 1500 Broadway, 12th Floor, New York, NY, 10036, US

(21) Appl. No.: 12/413,622

(22) Filed: Mar. 30, 2009

(51) Int. Cl. B62M 1/14; A61G 9/00

(52) U.S. Cl. 280/250.1; 4/450

(57) ABSTRACT

A waste disposal system, the waste disposal system including: (a) a sitting surface, for supporting a body of a user; and (b) a flexible basin including a drainage hole at a lower part of the flexible basin, wherein a rim of the flexible basin is connected to the sitting surface; wherein a shape of the flexible basin may take a first shape and a second shape, the first shape being a non-operational shape, and the second shape being a basin for guiding urine of the user to the drainage hole; wherein a distance between the sitting surface and the drainage hole is different between the first shape and a second shape.

### FIELD OF THE INVENTION

The invention relates to methods and systems for disposal of waste.

### BACKGROUND OF THE INVENTION

Disposing of human waste, and especially of urine, is a task that requires solutions that are both efficient, accessible, and hygienic. Several sectors of the population encounter different problems when looking for disposal solutions. For example, urinating is known to be a problematic task for handicapped women in wheelchairs.

While handicapped men can manage using a urinal bottle to dispose of the urine, women cannot. They need assistance to lift themselves from the seat in order to urinate into a lavatory seat.

The solutions offered by the prior art are far from satisfactory. Some of them are:
a. Adult diapers, such as those available from the Anhui company, in Hefei, Anhui, China. These are totally unacceptable for users with healthy bladder control.
b. Support arms around the toilet seat for the user to lift herself by the force of her arms. These are useful only for some women whose arms are strong enough to lift themselves between chairs.
c. Mechanisms for lifting patients from the wheelchair to and from the toilet, such as the “Apexlift STELLA Electric Stand Assist Lift” available from http://www.startracksmobility.corn/index.html. This solution requires assistance from a caregiver and is in itself a device as big as the wheelchair. Also, this device requires a conventional toilet to be available.
d. Female urinal funnels, as available form Ursec Urinal, Providence, R.I., USA. These devices are intended for women lying down, and are not suitable for a woman seated in a wheelchair.
e. U.S. Pat. No. 4,747,166 discloses a device that applies compressed air and vacuum for helping men and women to relieve their bladder. This device is the most advanced prior art that the present inventor has found, but in this solution, the urine flows along the body of the user and along the surface of the device, necessitating to clean each of them after the process.

The prior solutions do not allow the user to sit naturally and comfortably in her wheelchair, urinate in privacy, and dispose of the urine after completion—all done without the need to manually access parts of her body that are not easily accessed in this posture.

For a woman, sitting in her wheelchair It would be very desirable to have a toilet that can serve handicapped women and be embedded into their wheelchair. Additionally, different sectors of the population would find use for systems and methods for disposing of waste, which are comfortable, accessible, and hygienic.

### SUMMARY OF THE INVENTION

A waste disposal system, the waste disposal system including: (a) a sitting surface, for supporting a body of a user; and (b) a flexible basin including a drainage hole at a lower part of the flexible basin, wherein a rim of the flexible basin is connected to the sitting surface; wherein a shape of the flexible basin may take a first shape and a second shape, the first shape being a non-operational shape, and the second shape being a basin for guiding urine of the user to the drainage hole; wherein a distance between the sitting surface and the drainage hole is different between the first shape and a second shape.

A method for operating a waste disposal system, the method including: (a) sitting on a sitting surface of the waste disposal system, when a flexible basin of the waste disposal system takes a first shape; and (b) urinating when sitting on the sitting surface, when the flexible basin takes a second shape; wherein the flexible basin comprises a drainage hole at a lower part of the flexible basin, wherein a rim of the flexible basin is connected to the sitting surface; wherein the first shape being a non-operational shape of the flexible basin, and the second shape being a basin for guiding urine of a user to the drainage hole; wherein a distance between the sitting surface and the drainage hole is different between the first shape and a second shape.

A wheelchair, the wheelchair including: (a) a frame structure; (b) multiple wheels connected to the frame structure; (c) a sitting surface, connected to the frame structure, for supporting a body of a user; and (d) a flexible basin including a drainage hole at a lower part of the flexible basin, wherein a rim of the flexible basin is connected to the sitting surface; wherein a shape of the flexible basin may take a first shape and a second shape, the first shape being a non-operational shape, and the second shape being a basin for guiding urine of the user to the drainage hole; wherein a distance between the sitting surface and the drainage hole is different between the first shape and a second shape.

### BRIEF DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views, in which:

FIGS. 1 through 7 illustrate a waste disposal system, according to different embodiments of the invention;

FIG. 8 illustrates a method for operating a waste disposal system, according to an embodiment of the invention;

FIG. 9 illustrates flowchart of a process for operating a waste disposal system, according to an embodiment of the invention; and

FIG. 10 illustrates wheelchair 400, according to an embodiment of the invention.

### DETAILED DESCRIPTION OF THE DRAWINGS

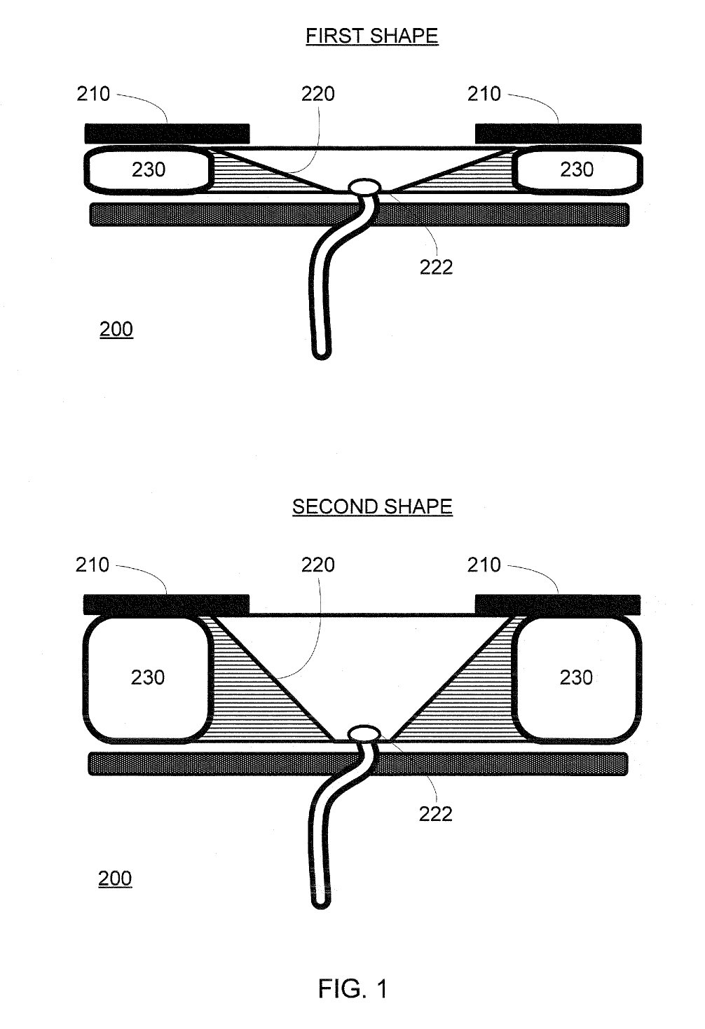

FIG. 1 illustrates waste disposal system 200, according to an embodiment of the invention. Waste disposal system 200 (hereinafter also simply referred to as system 200) includes sitting surface 210, for supporting a body of a user; flexible basin 220 that includes drainage hole 222 at a lower part of flexible basin 220, wherein a rim of the flexible basin is connected to sitting surface 210.

A shape of flexible basin 220, being flexible, may take different shapes, among which are at least a first shape and a second shape, the first shape being a non-operational shape, and the second shape being a basin for guiding urine of the user to drainage hole 222; wherein a distance between sitting surface 210 and drainage hole 222 is different between the first shape and a second shape.

Waste disposal system 200 is illustrated in FIG. 1 twice, by two cross sectional views, once when flexible basin 220 takes the first shape (denoted “first shape”) and once when flexible basin 220 takes the second shape (denoted “second shape”).

It is noted that according to different embodiments of the invention, waste disposal system 200 may be installed for different uses, e.g. on a wheelchair, on another type of chair, in a vehicle seat, at an aircraft sit, and so forth. As aforementioned, the distance between sitting surface 210 and drainage hole 222 changes at different times and between an operational state to a non-operational state of waste disposal system 200.

According to an embodiment of the invention, sitting surface 210 is substantially stationary (e.g. in relation to an external system such as a wheelchair, a room, or a vehicle), and a lower portion of flexible basin 220 (and especially drainage hole 222) may move in relation to sitting surface 210. According to another embodiment of the invention, a lower portion of flexible basin 220 (and especially drainage hole 222) is substantially stationary (e.g. in relation to an external system), and sitting surface 210 may move in relation to drainage hole 222. Alternatively, both of sitting surface 210 and drainage hole 222 may move, both in relation to each other, and in relation to an external system.

As will be discussed below, different mechanisms may be implemented for changing the distance between sitting surface 210 and drainage hole 222. Some examples for such means are hydraulic means, pneumatic means, different kinds of motors (electric or not), manual operation, and so forth. Also, the means for changing said distance may be for changing the distance of both of those components in relation to each other (e.g. by being connected to both sitting surface 210 and to drainage hole 222 or other part of a lower portion of flexible basin 220), or for changing a distance of one of said components in relation to an external system (e.g. to distance sitting surface 210 from a chassis of the wheelchair). It is further noted that more than a single mechanism may be implemented for changing the distance between sitting surface 210 and drainage hole 222.

According to an embodiment of the invention, waste disposal system 200 includes mechanical means for changing a shape of flexible basin 220 from the first shape to the second shape. As aforementioned, the mechanical means may apply force to at least one of sitting surface 210 and flexible basin 220 (e.g. to a lower portion thereof), for changing the shape of flexible basin 220 from the first shape to the second shape, or to otherwise achieve this goal (it should be further noted that according to other embodiments of the invention, non-mechanical or partly-mechanical solutions may also be implemented).

According to an embodiment of the invention, the mechanical means include elevating means for elevating sitting surface 210 in relation to a wheelchair on which the disposal system 200 is mounted, in cases where waste disposal system 200 is a wheelchair mounted waste disposal system.

According to an embodiment of the invention, the mechanical means include at least one inflatable compartment 230 located below sitting surface 210, for changing a distance between flexible basin 220 and drainage hole 222. The at least one inflatable compartment 230 may be a tube (e.g. a rubber tube similar to inner-tube—such as an inner tube of a scooter, or other type of toroidal tube), but may take any form. It is noted that according to such as embodiment of the invention, waste disposal system 200 conveniently further include a pump or a pressurized gas tank, for inflating at least one inflatable compartment 230, and means (such as valve) for deflating the at least one inflatable compartment 230.

According to an embodiment of the invention, flexible basin 220 is made from a stretchable matter, wherein at least a portion of flexible basin 220 is being stretched when a shape of flexible basin 220 is being changed from the first shape to the second shape. For example, a lower portion of flexible basin 220 may be connected to a chassis of a wheelchair, and elevating sitting surface 210 may result in a stretching of a flexible basin 220 that is made from a stretchable matter to the shape of a basin. According to another embodiment of the invention, flexible basin 220 may be stretched downwards in relation to sitting surface 210

According to an embodiment of the invention, waste disposal system 200 further includes a user interface (not shown) for controlling a modification of flexible basin 220 from the first shape to the second shape. The user interface may include buttons, handles, levers, or other means of controlling a modification of flexible basin 220. According to an embodiment of the invention, the user interface allows a manual modification of the shape of flexible basin 220 (e.g. by elevating sitting surface 220 in relation to drainage hole 222). According to an embodiment of the invention, the user interface includes controls for controlling a modification of a shape of flexible basin 220 by another mechanism (such as the mechanism discussed above). It is noted that system 200 may include additional components for controlling the modification (or other changes and movements in system 200), such as electrical position switch and so forth.

As suggested above, according to an embodiment of the invention, system 200 is a wheelchair mounted waste disposal system for disposing of wastes of a person using a wheelchair who is sitting on sitting surface 210. Conveniently, using system 200 by the person who uses the wheelchair would not require the person to move out of the wheelchair, and usually such usage would also not require an assistance of another person. According to an embodiment of the invention, the person who uses the wheelchair can use a control interface to command a changing of the shape of flexible basin 220 to the operational second shape (e.g. by pressing a button), wait for a completion of the shape changing (e.g. until a full extension of inflatable compartment 230), use system 200 for urinating (or other waste disposal), and command a changing of the shape of flexible basin 220 back to the non-operational first shape (e.g. by pressing a button). Before changing back to the non-operation shape, the person may, according to an embodiment of the invention, command (or wait for automatic execution of) other operations by system 200, such as (depending on the embodiment of the invention) flushing.

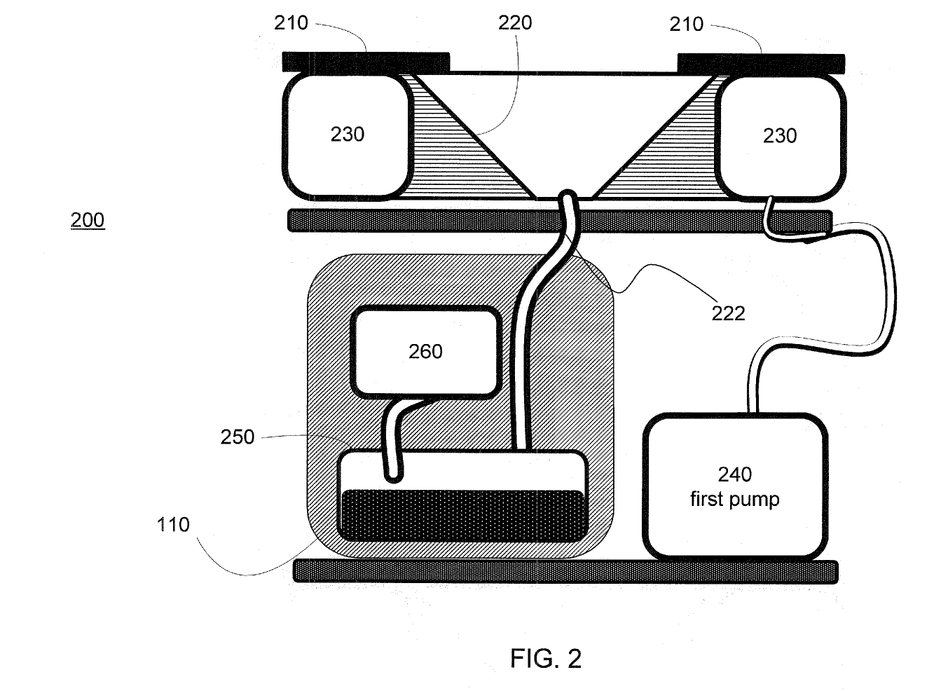

FIG. 2 illustrates waste disposal system 200, according to an embodiment of the invention. Illustrated in FIG. 2 is first pump 240 (which could be replaced, in an embodiment of the invention, by a pressurized gas tank) for inflating at least one inflatable compartment 230. It is noted that component 240 may further participate in the deflating the at least one inflatable compartment 230. Additionally, component 240 may provide hydraulic pressure, instead of gas pressure.

System 200 may also include tank 250 for storing the disposed waste (denoted 110). According to an embodiment of the invention, system 200 further includes second pump 260, connected to flexible basin 220 (and especially to drainage hole 222), for sucking fluid toward a lower part of flexible basin 220. The suction may be achieved by vacuum pumping the fluid towards second pump 260, via drainage hole 222.

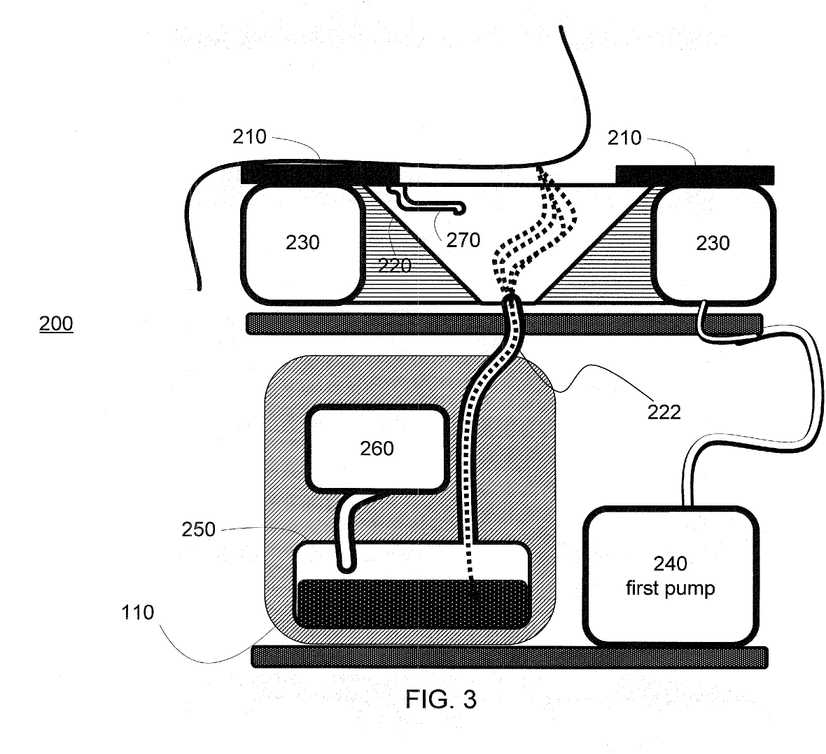

According to an embodiment of the invention, second pump 260 is further for sucking the fluid for changing a course of the urine before the urine contacts a surface of the system (see illustration in FIG. 3).

According to an embodiment of the invention, at one least component of the system 200 if that latter is a wheelchair mounted waste disposal system, may be statically connected to the wheelchair. According to an embodiment of the invention, system 200 may include means (nor shown) for attaching (and potentially detachably attaching) system 200 to the wheelchair, or to another object.

According to an embodiment of the invention, system 200 further includes washing tube 270, for flushing fluid into flexible basin 220 (e.g. for cleaning flexible basin 220).

Referring now to FIGS. 1 and 2 for explanation of an operation of the system, according to an embodiment of the invention. Shown is a side view of system 200, according to an embodiment of the invention. Not shown in those figures are parts of the wheelchair that are not related to the invention (if applicable), and the fact that the user is lifting her skirt or dress within the sitting compartment of the chair (if applicable), so that her clothes are not in the way of the urine flow.

A user (possibly a woman) is sitting on a wheelchair (not shown). The seat of the chair carries a tube (inflatable compartment 230), e.g. such as a scooter wheel inner tube that can be (in top view) circular or square. A membrane that serves as flexible basin 220 that may be glued or otherwise connected to an inner equator of the tube is suspended. Drainage hole 222 in the center of flexible basin 220 is fixed to a hole in the center of the seat. According to an embodiment of the invention, in the non-operational state of system 200, inflatable compartment 230 may be slightly inflated, to serve as a soft sitting cushion, causing the periphery of flexible basin 230 to elevate and create a shallow vertical cone with the apex in the draining hole 222.

According to an embodiment of the invention, second pump 260 may be part of a suction machine, such as an air/fluid vacuum cleaner that can suck both air and fluids, and may be located near or under the seat. A pumping sub system of the vacuum machine is conveniently operational to suck air and fluids from the flexible basin 222 and cause the fluids to collect in a waste container 240. An air compressor, acting as first pump 240, such as the model model DP0125 available from NITTO, in Ota-ku, Tokyo, Japan, may also be located under the seat, and be connected to the inflatable compartment 230 by an air pipe. Both machines may be located on a floor of the wheelchair under the seat, or can be located on a separate platform with the fluid and electric supplies connected via connectors.

According to such an embodiment of the invention, when the user feels that he or she needs to urinate, she operates system 200 so that he or she can relieve his or her bladder without the assistance of others, without getting out of the chair, and without staying close to the disposed urine and without having skin in contact with dirty surfaces.

The user may for example roll the wheelchair to a private spot (not necessarily a bathroom) and activates the first pump 240, e.g. using a switch on the system 200 itself or remotely installed on the armrest of the chair. The air is pumped into inflatable compartment 230 and inflates it to its maximum elevation, elevating the user away from drainage hole 222 and at the same time creating a steep basin under the user.

Before urinating, the user may activate second pump 260 (or a parallel vacuum machine). As the user does not seal the basin with her body, and air can flow in between her hips and behind her back, the vacuum creates a fast airflow streaming down the flexible basin 220 into drainage hole 222. This is a major difference over the prior art that applies vacuum to suck the urine out of a closed compartment. The fast free flow of air and fluid causes most of the urine to flow from the body into drainage hole 222 through the air, without touching any part of the body and the flexible basin 220.

When the user has finished, she may keep the vacuum operating (if applicable) for a few more seconds, drying the body and flexible basin 220. When she feels that her body is dry, she may than stop second pump 260, and command a changing of the shape of flexible basin 220 back to the first mode (e.g. by releasing air from inflatable compartment 230). Again, enough air may remain in inflatable compartment 230 for comfortable sitting.

According to an embodiment of the invention, system 200 includes a pump (which may be first or second pump, or another pump) which facilitates blowing of air (usually warm) onto a body of the user, for drying the body of the user more thoroughly.

It is noted that, according to an embodiment of the invention, some aforementioned described components of system 200 may be external to system 200 (e.g. in a service location such as a toilet), and system 200 may connect thereto. Such components may optionally serve more than one system 200. for example, one or more pumps may be external to system 200.

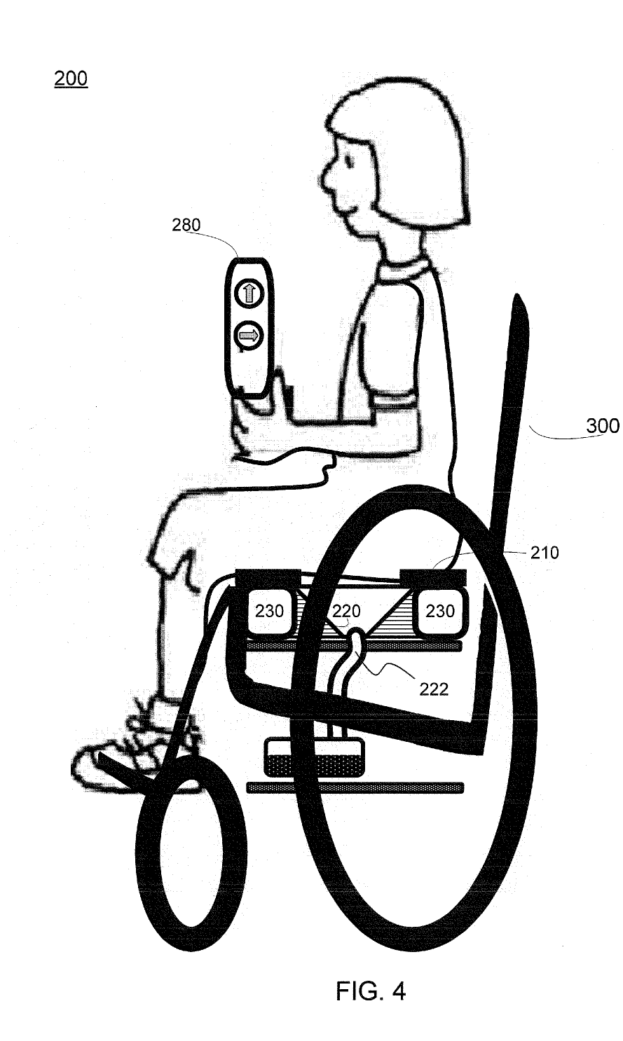

FIG. 4 illustrates a user sitting on system 200, according to an embodiment of the invention, and a control panel 280 for controlling system 200, e.g. as explained above. System 200 is illustrated as installed on a wheelchair 300.

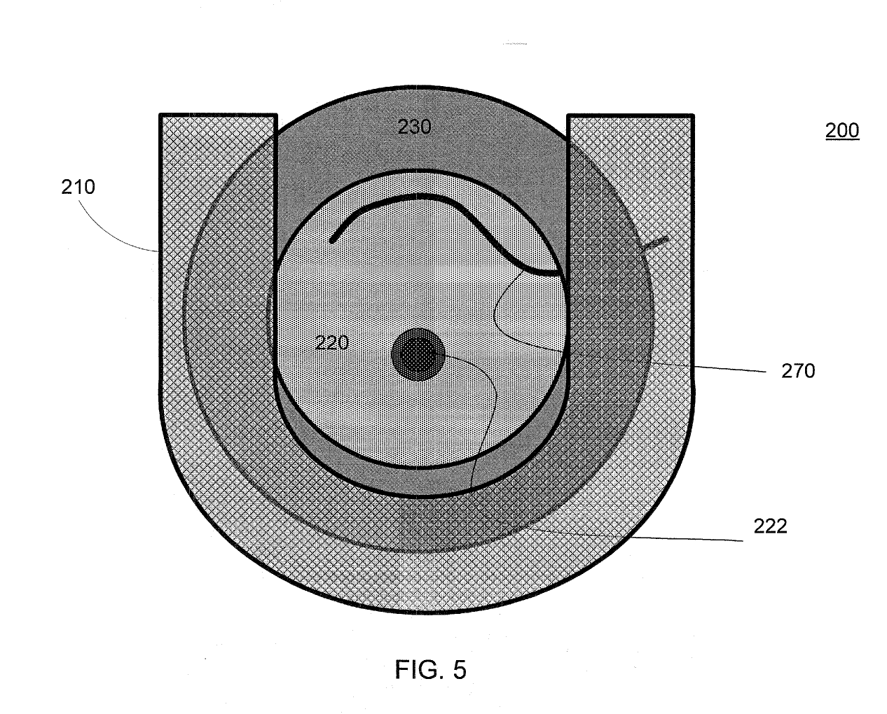

FIG. 5 is a top view illustration of system 200, according to an embodiment of the invention inflatable compartment 230 supports the flexible basin 220, flexible basin 220 may be glued, welded, or otherwise connected to sitting surface 210 or to inflatable compartment 230.

Optionally, a washing hose 270 can be installed and used to wash the flexible basin 230 or other components after use. According to an embodiment of the invention, the wash water will be sucked out by a pump of system 200, and the wet basin will be dried by the streaming air.

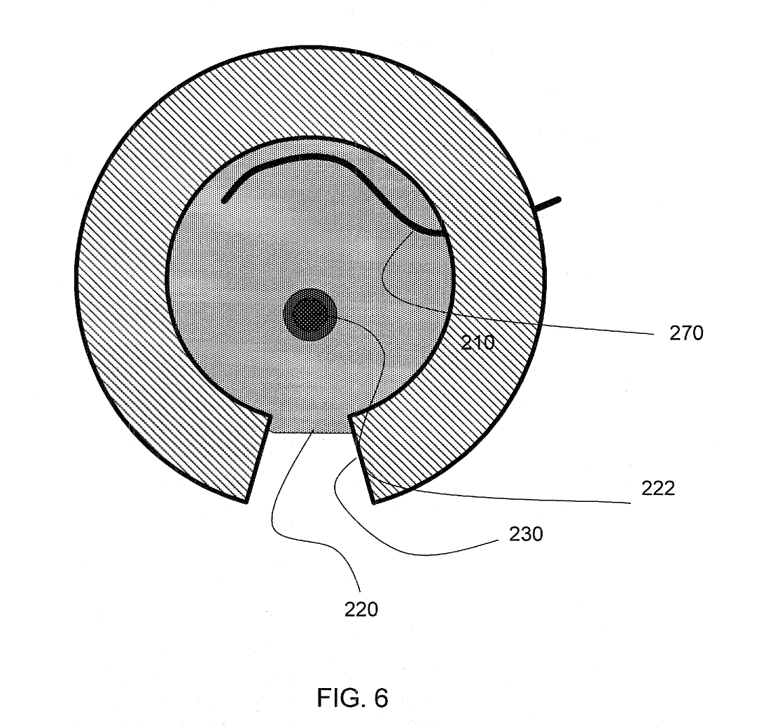

It is noted that one or more sitting surfaces 210 may be one or more surfaces of inflatable compartment 230, but this is not necessarily so. FIG. 6 is a top view illustration of system 200, according to such an embodiment of the invention. According to an embodiment of the invention, inflatable compartment 230 is not toroidal but has the shape of the letter “C” (or other opening) and has an opening to one side—preferably forward, but possibly backward or both. The opening enables the user to access her body, if needed, and enhances the airflow that carries the urine towards drainage hole 222.

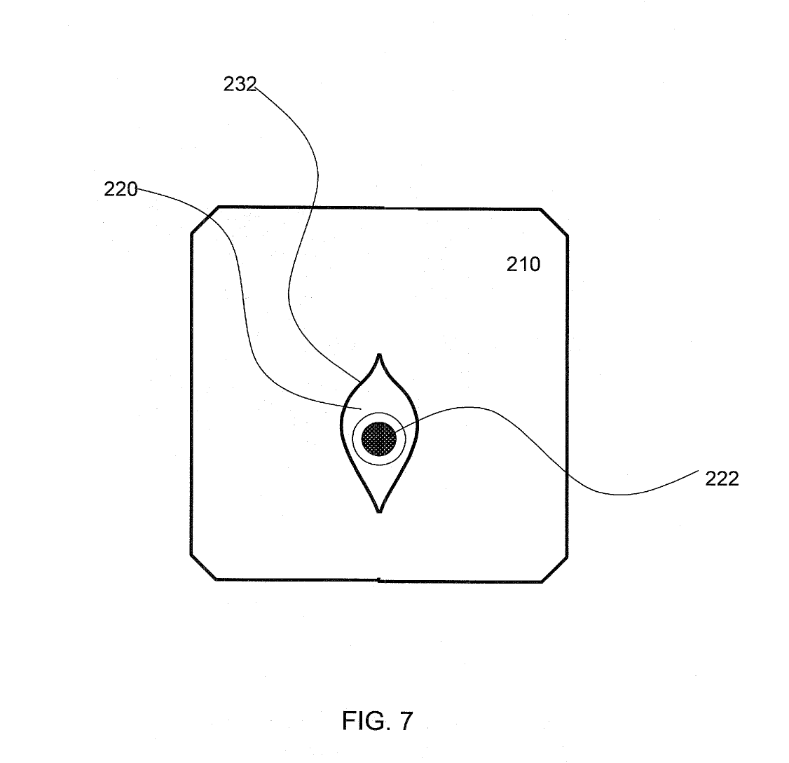

FIG. 7 is a top view illustration of system 200, according to an embodiment of the invention. According to an embodiment of the invention, sitting surface 210 is substantially a square seat, where the flexible basin 220 may be attached to a non-circular opening 232 designed in a shape that has a minimal area and still collects all of the urine effectively. The small flexible basin 220 may have a steeper slope and improves the flow of the fluid directly into drainage hole 222. Another advantage of the smaller opening is that the seating surface is larger, and the pressure on the body is lower and the sitting is more comfortable and stable.

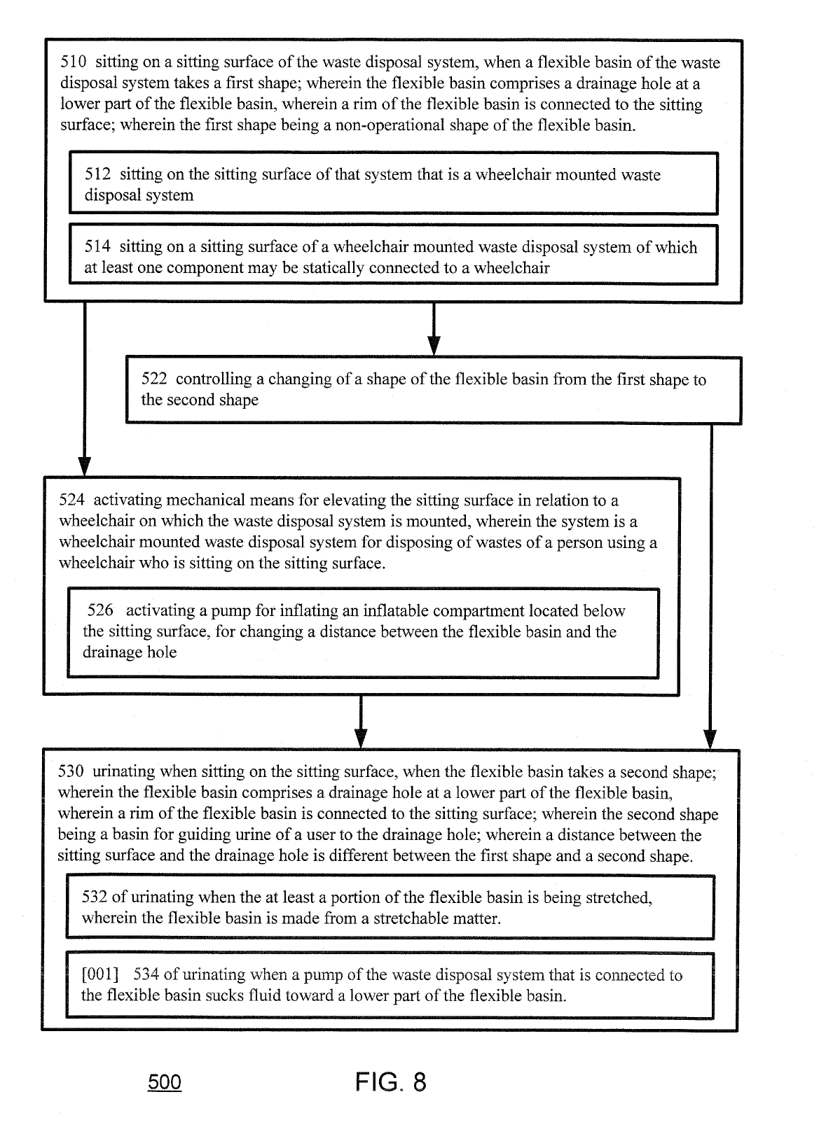

FIG. 8 illustrates method 500 for operating a waste disposal system, according to an embodiment of the invention.

Method 500 includes stage 510 of sitting on a sitting surface of the waste disposal system, when a flexible basin of the waste disposal system takes a first shape; and stage 530 of urinating when sitting on the sitting surface, when the flexible basin takes a second shape; wherein the flexible basin includes a drainage hole at a lower part of the flexible basin, wherein a rim of the flexible basin is connected to the sitting surface; wherein the first shape being a non-operational shape of the flexible basin, and the second shape being a basin for guiding urine of a user to the drainage hole; wherein a distance between the sitting surface and the drainage hole is different between the first shape and a second shape.

Referring to the examples set forward in the previous drawings, the sitting surface is sitting surface 210, the flexible basin is flexible basin 220, the drainage hole is drainage hole 222, and so forth.

According to an embodiment of the invention, stage 510 includes stage 512 of sitting on the sitting surface of that system that is a wheelchair mounted waste disposal system.

According to an embodiment of the invention, stage 510 includes stage 514 of sitting on a sitting surface of a wheelchair mounted waste disposal system of which at least one component may be statically connected to a wheelchair.

According to an embodiment of the invention, method 500 further includes stage 522 (which is conveniently carried out before stage 530, but not necessarily so) of controlling a changing of a shape of the flexible basin from the first shape to the second shape.

According to an embodiment of the invention, method 500 further includes stage 524 (which is conveniently carried out before stage 530, but not necessarily so) of activating mechanical means (or other means) for elevating the sitting surface in relation to a wheelchair on which the waste disposal system is mounted (or otherwise changing the distance between the sitting surface and the drainage hole), wherein the system is a wheelchair mounted waste disposal system for disposing of wastes of a person using a wheelchair who is sitting on the sitting surface. It is noted that stage 523 may be implemented for systems that are not wheelchair mounted, mutatis mutandis.

According to an embodiment of the invention, stage 523 includes stage 526 of activating a pump for inflating an inflatable compartment located below the sitting surface, for changing a distance between the flexible basin and the drainage hole.

According to an embodiment of the invention, stage 520 includes stage 532 of urinating when the at least a portion of the flexible basin is being stretched, wherein the flexible basin is made from a stretchable matter.

According to an embodiment of the invention, stage 530 includes stage 534 of urinating when a pump of the waste disposal system that is connected to the flexible basin sucks fluid toward a lower part of the flexible basin.

It is clear to a person who is skilled in the art that other embodiments of system 200 discussed above may also be implemented as part of method 500, even if not explicitly elaborated.

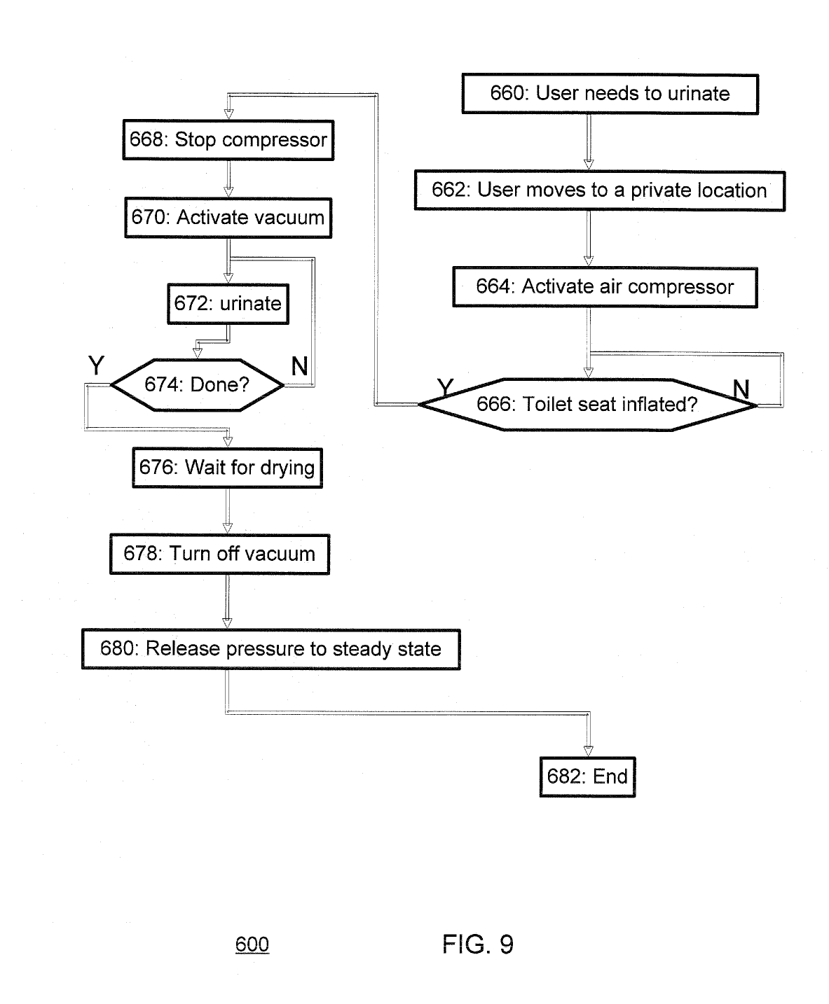

FIG. 9 illustrates flowchart of a process 600 for operating a waste disposal system, according to an embodiment of the invention.

When the user needs 660 to urinate, she moves 662 to a private location, activates 664 the air compressor and waits 666 until the tube is inflated. Then she stops 668 the compressor and activates 670 the vacuum. She then urinates 672 and waits 674 until done. She then waits 676 for her body to be dried by the streaming air and turns off 678 the vacuum and releases 680 air from the system. When the seat assumes its steady state elevation, the process ends 682, it is noted that not all of the stages needs to be carried out every time.

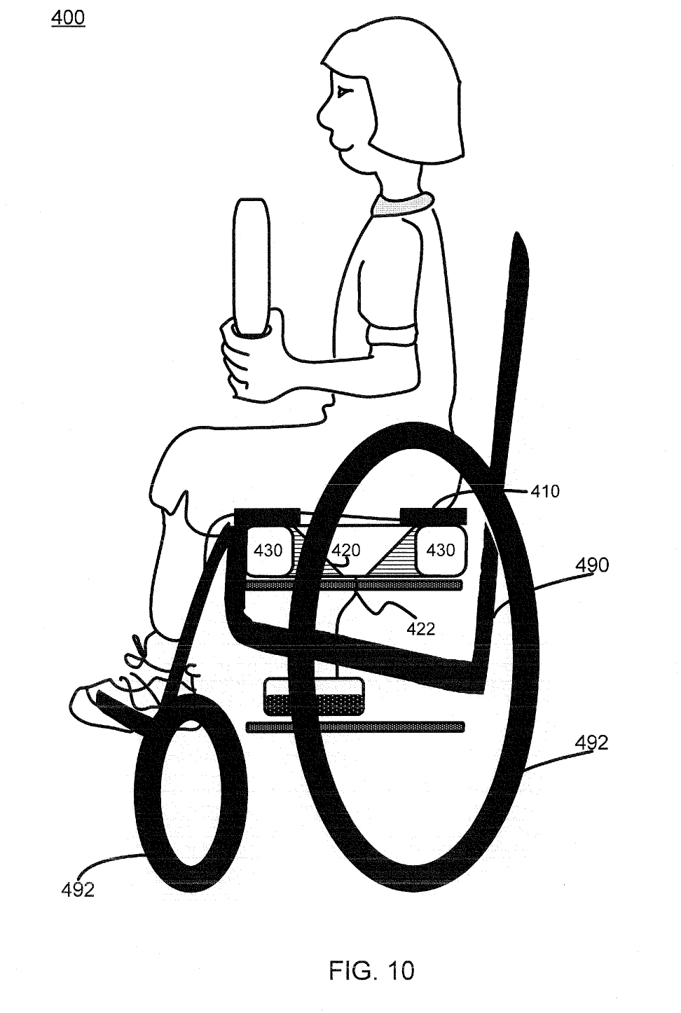

FIG. 10 illustrates wheelchair 400, according to an embodiment of the invention. Wheelchair 400 includes frame structure 490; multiple wheels 492 connected to frame structure 490; a sitting surface 410, connected to frame structure 490, for supporting a body of a user; flexible basin 420 that includes a drainage hole 422 at a lower part of the flexible basin 420, wherein a rim of flexible basin 420 is connected to sitting surface 410; wherein a shape of flexible basin 420 may take a first shape and a second shape, the first shape being a non-operational shape, and the second shape being a basin for guiding urine of the user to drainage hole 422; wherein a distance between sitting surface 410 and drainage hole 422 is different between the first shape and a second shape.

It is noted that operation of different components of wheelchair 400 may be similar to an operation of parallel components of system 200 (if applicable). For example, an operation of inflatable compartment 430 may be similar to an operation of inflatable compartment 230 of system 200. It is further noted that wheelchair 400 may further include additional components similar to those disclosed in relation to system 200. Also, a method for using wheelchair 400 for disposal of waste may be similar to method 500, mutatis mutandis.

It is noted that the pertaining to the term stretchable, while an interpretation of the term as common in the art may be applied, another definition which may be utilized (while not intending to limit the scope of the invention in any way) is—a property of a fabric or a sheet of material, that enables it to have a relatively smooth surface when stretched, and yet collapse into a small, possibly wrinkled volume when not stretched. An elastic material is stretchable, and a non-elastic material shaped into a suitable geometry can also be stretchable. A non elastic sheet that is shaped as a truncated cone, is stretchable when its two bases are pulled away from each other.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

1. A waste disposal system, the waste disposal system comprising:
a sitting surface, for supporting a body of a user; and
a basin comprising a drainage hole at a lower part of the basin, wherein a rim of the basin is coupled to the sitting surface; and
an element selected from a pump and a vacuum machine, coupled to the basin, for sucking fluid toward the lower part of the basin and for providing airflow streaming down the basin, so as to change a course of a urine before the urine contacts a surface of the basin.

2. The system of claim 1, wherein the system is a wheelchair mounted waste disposal system for disposing of wastes of a person using a wheelchair who is sitting on the sitting surface.

3. The system of claim 1, further comprising mechanical means for changing a shape of the basin from the first shape to the second shape.

4. The system of claim 3, wherein the mechanical means comprise elevating means for elevating the sitting surface in relation to a wheelchair on which the waste disposal system is mounted, wherein the system is a wheelchair mounted waste disposal system for disposing of wastes of a person using a wheelchair who is sitting on the sitting surface.

5. The system of claim 3, wherein the mechanical means comprise an inflatable compartment located below the sitting surface, for changing a distance between the basin and the drainage hole.

6. The system of claim 1, wherein the basin is made from a stretchable matter, wherein at least a portion of the basin is being stretched when a shape of the basin is being changed from the first shape to the second shape.

7. The system of claim 1, further comprising a user interface for controlling a modification of the basin from the first shape to the second shape.

8. The system of claim 1, wherein a shape of the basin may take a first shape and a second shape the first shape being a non-operational shape, and the second shape being a basin for guiding urine of the user to the drainage hole; wherein a distance between the sitting surface and the drainage hole is different between the first shape and a second shape.

9. (canceled)

10. The system of claim 2, wherein at least one component of the wheelchair mounted waste disposal system may be statically coupled to a wheelchair.

11. The system of claim 1, further comprising a washing tube, for flushing fluid into the basin.

12. A method for operating a waste disposal system, the method comprising:
sitting on a sitting surface of the waste disposal system, wherein the sitting surface is coupled to a basin of the waste disposal system wherein the basin comprises a drainage hole at a lower part of the basin and wherein a rim of the basin is coupled to the sitting surface;
urinating when sitting on the sitting surface; and
activating a pump or a vacuum machine, coupled to the basin, for sucking fluid toward the lower part of the basin and for providing airflow streaming down the basin, so as to change a course of a urine before the urine contacts a surface of the basin.

13. The method of claim 12, wherein the sitting comprises sitting on the sitting surface of that system that is a wheelchair mounted waste disposal system.

14. The method of claim 12, further comprising controlling a changing of a shape of the basin from a first shape to a second shape; wherein the first shape being a non-operational shape of the basin, and the second shape being the basin for guiding urine of a user to the drainage hole: wherein a distance between the sitting surface and the drainage hole is different between the first shape and a second shape.

15. The method of claim 12, further comprising activating mechanical means for elevating the sitting surface in relation to a wheelchair on which the waste disposal system is mounted, wherein the system is a wheelchair mounted waste disposal system for disposing of wastes of a person using a wheelchair who is sitting on the sitting surface.

16. The method of claim 15, wherein the activating of the mechanical means comprises activating a pump for inflating an inflatable compartment located below the sitting surface, for changing a distance between the basin and the drainage hole.

17. The method of claim 12, wherein the urinating comprises urinating when the at least a portion of the basin is being stretched, wherein the basin is made from a stretchable matter.

18. (canceled)

19. The method of claim 13, wherein the sitting comprises sitting on a sitting surface of a wheelchair mounted waste disposal system of which at least one component may be statically coupled to a wheelchair.

20. A wheelchair, the wheelchair comprising:
a frame structure;
multiple wheels coupled to the frame structure;
a sitting surface, coupled to the frame, structure, for supporting a body of a user; and
a basin comprising a drainage hole at a lower part of the flexible basin, wherein a rim of the flexible basin is coupled to the sitting surface; and
an element selected from a pump and a vacuum machine, coupled to the basin, for sucking fluid toward the lower part of the basin and for providing airflow streaming down the basin, so as to change a course of a urine before the urine contacts a surface of the basin.
